(19) United States
(12) Patent Application Publication
(10) Pub. No.: US 2009/0016334 A1
(43) Pub. Date: Jan. 15, 2009

(54) SECURED TRANSMISSION WITH LOW OVERHEAD

(75) Inventors: Dan Lars Anders Forsberg, Helsinki (FI); Seppo Ilmari Vesterinen, Oulu (FI); Pentti Valtteri Niemi, Helsinki (FI); Sami Kekki, Helsinki (FI)

Correspondence Address: DITTHAVONG MORI & STEINER, P.C., 918 Prince St., Alexandria, VA, 22314, US

(73) Assignee: Nokia Corporation, Espoo (FI)

(21) Appl. No.: 11/775,006

(22) Filed: Jul. 9, 2007

(51) Int. Cl. H04L 12/56; H04J 3/16

(52) U.S. Cl. 370/389; 370/469

(57) ABSTRACT

The present invention relates to a method, tunnel protocol layer, and network device for securing a data packet on a network link. A security layer is provided in the tunneling protocol layer of the wireless network, and a secured data packet is generated by adding to the data packet a header in accordance with said security layer of the tunneling protocol. The secured data packet is then transmitted over the link by using a link layer connection.

### FIELD OF THE INVENTION

The present invention relates to a method, tunnel protocol layer, and network device for securing a data packet on a network link, e.g. a link between an IP-based network and an access device of a wireless network.

### BACKGROUND

To enhance capabilities of 3GPP (3^{rd} Generation Partnership Project) systems to cope with the rapid growth in IP (Internet Protocol) data traffic, the packet-switched technology utilized within present 3G mobile networks requires further enhancement. Hence, a long-term evolution (LTE) of the 3GPP access technology is under consideration. LTE aims at reduced latency, higher user data rates, improved system capacity and coverage, and reduced overall cost for the operator. Additionally, it is expected that IP based 3GPP services will be provided through various access technologies. A mechanism to support seamless mobility between heterogeneous access networks, for example industrial wireless local area network (I-WLAN) and 3GPP access systems, is a useful feature for future network evolution. In order to achieve this, migration of the network architecture as well as an evolution of the radio interface are ongoing processes. Further, system architecture evolution (SAE) concerns architectural considerations as end-to-end systems aspects, including core network aspects and the study of a variety of IP connectivity access networks.

As decided in 3GPP, ciphering function and/or compression function in user plane (also called U-plane) will be terminated in the access device of the wireless network (e.g. evolved Node B (eNB) or base station), in other words ciphering and/or compression should be completed between user equipment (UE) and a evolved Node B (eNB). For securing the traffic between the wireless network access device and the user plane element of the core network, such as an access gateway (aGW) of the evolved SAE packet core, a security association is needed.

The next-generation Internet Protocol version 6 (IPv6) eliminates the barriers to globally unique IP addressing and thereby alleviates the need for specific application layer gateways and network address translation. Furthermore, IPv6 provides solutions to the above security problem through built-in security on an end-to-end basis to maintain application transparency.

IPSec which is supported in the older IP version 4 (IPv4) and also in IPv6 can secure both transmission control protocol (TCP) and user datagram protocol (UDP) traffic. Through the use of a native authentication header (AH) and encrypted security payload (ESP), the entire packet (including the IP header) can be secured. IPv6 also provides a basis for secure, worldwide commerce and inter-domain security through multi-vendor compliance with Internet key exchange (IKE) to enable operators to broker transactions on behalf of their subscribers and offer value-added services resulting in micro-payments. Multiprotocol label switching (MPLS) may then securely transport the traffic by supporting security constraints in traffic engineering, whereby specific transactions are required to traverse secure paths bounded by MPLS routers with IPSec security associations (SAs).

Furthermore, Network Domain Security for IP (NDS/IP) as specified in the 3GPP specification TS 33.210 has been proposed for protection of signaling messages of the Session Initiation Protocol (SIP) in the IP multimedia subsystem (IMS) in the core network. SIP messages are carried within the IMS within messages of the user plane of the GPRS (General Packet Radio Services) tunneling protocol (GTP-U).

However, for time-sensitive packets, such as VoIP (voice over IP) packets, the packet overhead on an S1 backhaul link between base stations (enhanced NodeBs (eNB)) and the core network (e.g. aGW) is unbearable in case an NDS/IP (IPSec) tunnel and a normal GTP protocol stack (e.g. IP/UDP/GTP) are used. In case SEC GWs are needed between eNBs and SAE GWs, IPSec transport mode cannot be used and the overhead is even bigger. There is thus a clear need to reduce the overhead for certain packet types, such as VoIP packets (32 bytes).

### SUMMARY

Thus, an applicable solution for reduced header size on the S1 link or other comparable links is needed.

According to various embodiments, there is provided a method for securing a data packet on a network, the method comprising:
providing a security layer in a tunneling protocol of said wireless network;
generating a secured data packet by adding to said data packet a header in accordance with said security layer of said tunneling protocol; and
using a link layer connection to transmit said secured data packet over said link.

Additionally, according to various embodiments, there is provided a tunneling protocol layer in a user plane stack, said tunneling protocol layer being configured to provide a security function between an access device of a wireless network and a user plane element of a core network, wherein a tunnel identifier of said tunneling protocol layer is mapped to a security association and a link layer, and wherein a secured data packet is transmitted over a link layer connection.

Furthermore, according to various embodiments, there is provided a network device for securing a data packet on a network link, the network device comprising:
a packet generation unit for generating a secured data packet by adding to said data packet a header in accordance with said security layer of a tunneling protocol; and
a transmitting unit for using a link layer connection to transmit said secured data packet over said link.

Additionally, an embodiment may be based on a software implementation where a computer program which may be stored on a computer-readable medium or downloadable from a network comprises code means for generating the above method steps when run on a computer or processor device.

Accordingly, packet overhead can be reduced by migrating a tunneling protocol and a security protocol. The security layer is built into the user plane of the tunneling protocol. Packets of the tunneling protocol can be transported over a link layer to thereby substantially reduce header overhead. As an example, the tunneling protocol (such as GTP or the like) can be merged with an IP-based security protocol or functionality (such as IPSec or the like).

Additionally, a tunnel identifier of the tunneling protocol could be mapped to a security association.

As an optional additional measure, overhead could be further reduced by introducing header compression for the proposed tunneling protocol (e.g. compressing the GTP user plane header and ESP related fields). According to specific examples, at least one of a sequence number (SN) field, security parameter index (SPI) field, and tunnel endpoint identifier (TEID) field could be compressed further.

As another option, special header compression could be used for ESP and GTP-U so as to effectively reduce at least one of GTP SN redundancy, ESP SN redundancy, TEID redundancy, and security parameter index (SPI) redundancy.

Accordingly, header size can be reduced and transport link utilization can be increased. If needed, ciphering/de-ciphering can be decoupled from the GTP tunnel end point if needed. The control plane of IP-based security protocols or layers (such as NDS, i.e. IETF IKEv2) could be reused.

The security association may be identified by a security parameter index or a tunnel endpoint identifier used for the user plane tunneling protocol (e.g. GTP) or a unique link layer end point identifier or a link layer tunnel end point identifier (e.g. MPLS tunnel or VLAN id).

Furthermore, the IP-based security protocol may be the IP Security or the Network Domain Security protocol.

At least one of the header and security related fields may be compressed prior to the transmission via said link layer connection. More specifically or as an additional measure, at least one of a sequence number field and a tunnel endpoint identifier may be compressed. Compression may be performed for example by using a Robust Header Compression scheme.

Further, a link layer tunnel may be created between the access device and a gateway device of a core network of said wireless network. In an example, the link layer tunnel may be a Multiprotocol Label Switching tunnel.

As an additional measure, a field which indicates a ciphered or non-ciphered packet may be added to the header. This allows decoupling of ciphering from the tunnel termination endpoint.

Tunnel endpoint identifiers (e.g. GTP TEIDs) may be remapped to security parameter indices (e.g. to security associations) by using handover signaling as the GTP TEIDs are User Equipment specific rather than eNB specific. The handover signaling may be configured to carry at least one of tunnel endpoint identifiers and security parameters indices. Thereby, the parameters do not need to be transferred in the data packet.

In an embodiment, a HFN+SN scheme of the radio link layer may be used for generating the header.

Tunnels may be mapped based on tunnel endpoint identifiers and link layer addresses. Thus, tunnel mapping can be achieved without knowledge of IP address or UDP port. Security associations may be mapped based on link layer addresses. Thus, tunnel mapping can be achieved without knowledge of IP address or UDP port or GTP TEID.

The header may be generated by combining an Encrypted Security Payload header with said tunneling protocol.

### BRIEF DESCRIPTION OF THE DRAWINGS

Other aspects and features will become apparent from the following detailed description considered in conjunction with the accompanying drawings. It is to be understood, however, that the drawings are designed solely for purposes of illustration and not as a definition of the limits of the invention, for which reference is to be made to the appended claims only. It should be further understood that the drawings are merely intended to conceptually illustrate the structures and procedures described herein. Therefore, any references to known network are to be considered as examples provided as illustration.

FIG. 1 shows high-level architecture for the evolved system in SAE;

FIG. 2 shows exemplary frame structures of an original packet and a tunneled packet;

FIG. 3 shows an exemplary structure of an evolved GTP header according to an embodiment;

FIG. 4 shows an exemplary frame format according to an embodiment;

FIG. 5 shows an exemplary structure of an ESP header; and

FIG. 6 shows a schematic block diagram of a network device according to an embodiment.

### DESCRIPTION OF EMBODIMENTS

Certain embodiments will now be explained in detail below with reference to the drawings attached hereto. The network elements, different networks, structure or the relative positions of these parts described in the embodiments, however, are only illustrative but not intended for limiting the scope of invention unless otherwise specified.

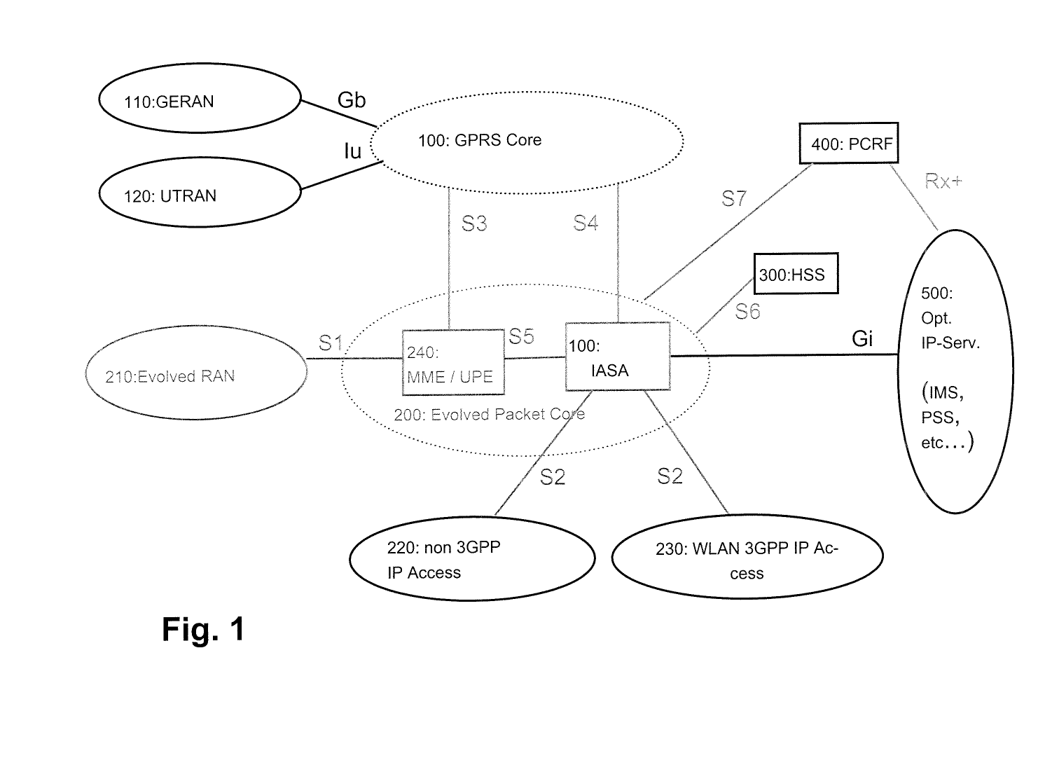

Now with reference to FIG. 1, the high level architecture for an evolved system according to the 3GPP long-term evolution (LTE) and system architecture evolution (SAE) is described, in which no roaming case is depicted. A network architecture baseline as the basis for further evolution of the architecture can be gathered from “3rd Generation Partnership Project; Technical Specification Group Services and System Aspects; 3GPP System Architecture Evolution: Report on Technical Options and Conclusions (Release 7)”, 3GPP TR 23.882 V1.2.3 (2006-06).

There is generally a GPRS core network 100 and an evolved packet core (EPC) network 200. User and bearer information exchange takes place between the GPRS Core network 100 and the EPC network 200 via an S3 link for inter 3GPP access system mobility in idle and/or active state. It is based on Gn reference point as defined between serving GPRS support nodes (SGSNs); in GSM, for instance, a SGSN keeps track of the location of an individual MS and performs security functions and access control. The SGSN also exists in the UMTS network, where it connects to the radio network controller over the lu-PS interface. The user plane has related control and mobility support between GPRS core network 100 and a 3GPP anchor in the inter access system anchor (IASA) 260 via an S4 link, which may also be based on Gn reference point as defined between SGSN and gateway GPRS support node (GGSN). In FIG. 1 an inter access system anchor (IASA) 260 represent both the 3GPP anchor and the SAE anchor (not shown).

Further, the GPRS Core network 100 is connected to the GSM EDGE radio access network (GERAN) 110 supporting the EDGE (Enhanced Data rates for Global Evolution) modulation technique which radio resources are connect via the Gb inter-face to the GPRS core network 100. Further, there is the UMTS Terrestrial Radio Access Network (UTRAN) 120 connected to the GPRS core network 100 via the lu interface. Access to radio resources of an evolved radio access network (eRAN) 210 is provided via a reference point S1 which constitutes a backhaul link for the transport of user plane and control plane traffic between access devices or base stations (i.e. eNBs) and the core network (i.e. aGW or SAE GW). The user plane is also provided via reference point S2 with related control and mobility support between wireless local network 3GPP IP access 220 or non 3GPP IP access 230 and the inter AS anchor.

By reference point S5 the user plane is provided with related control and mobility support between mobility management element (MME) and user plane element (UPE) 240 and the inter access system anchor (IASA) 260, which is a combination of an 3GPP anchor and an SAE anchor. Alternatively, MME/UPE and 3GPP anchor may be combined into one entity and the SAE anchor may be a separate entity.

Transfer of subscription and authentication data for authenticating/authorizing (AAA interface) user access to the evolved system is enabled via reference point S6 that connects a home subscriber server (HSS) 300 with the EPC 200. In general, the HSS 300 comprises the many database functions that are required in next generation mobile networks. These functions may include the HLR (Home Location Register), DNS (Domain Name Servers) and security and network access databases. Transfer of quality of service (QoS) policy and charging rules from policy charging rules function (PCRF) 400 to a policy and charging enforcement point (PCEP) is provided via reference point S7. The reference point Gi between the IASA 260 and the packet data network (PDA) 500. The PDA 500 may be an operator external public or private packet data network or an intra operator packet data network, for example for provision of IP multimedia subsystem (IMS) services. The IMS enables the support for IP multimedia applications within the UMTS system.

The scope of ciphering is from the ciphering function at the UPE to the ciphering function in the user equipment (UE), such as a mobile station (MS) or mobile equipment (ME). Ciphering can only be used if both the user equipment and the network support ciphering. Ciphering is set on in UPE parameters, wherein there are two options to do this: 1) UPE ciphering data is pre-configured to the MME, or 2) MME negotiates with UPE during initial access or handover. With both options, MME can update UPE with security policy, like decision to use certain algorithm, priority order to use different algorithms and so forth. Then, the user equipment and the network will use an agreed ciphering algorithm in ciphering the data transfer. UE and UPE will store the information of ciphering info/per tunnel base. Relevant ciphering parameters may be at least one of ciphering key, frame-dependent input and transfer direction. Between E-UTRAN NodeB (eNB) and UPE the GTP-U may be used as tunneling protocol. In other words, with respect to GPRS based networks an GTP-U can be utilized for carrying necessary security information between the user plane element UPE and the relevant E-UTRAN NodeB (eNB).

The packet overhead on the above mentioned S1 backhaul link is however undesirable, for certain kinds of packets, such as VoIP packets. Hence, measures to reduce the header size of the IP/ESP/UDP/GTP-U/IP/UDP/RTP/VoIP headers are required.

It is therefore proposed to use the GTP-U tunneling protocol between the access device (e.g. eNB) and UPE (e.g. aGW or SAE GW) to provide header compression and ciphering functions.

The current S1-U protocol is based on the existing GTP-U protocol that is transported over IP/UDP. The transport overhead is critical on the last mile links down to the eNBs and with standard GTP it becomes unbearable with VoIP over IPv6. Also the operators will require a secured S1-U e.g. using ESP due to PDCP (Packet Data Conversion Protocol) movement down to the eNB that will further increase transport overhead.

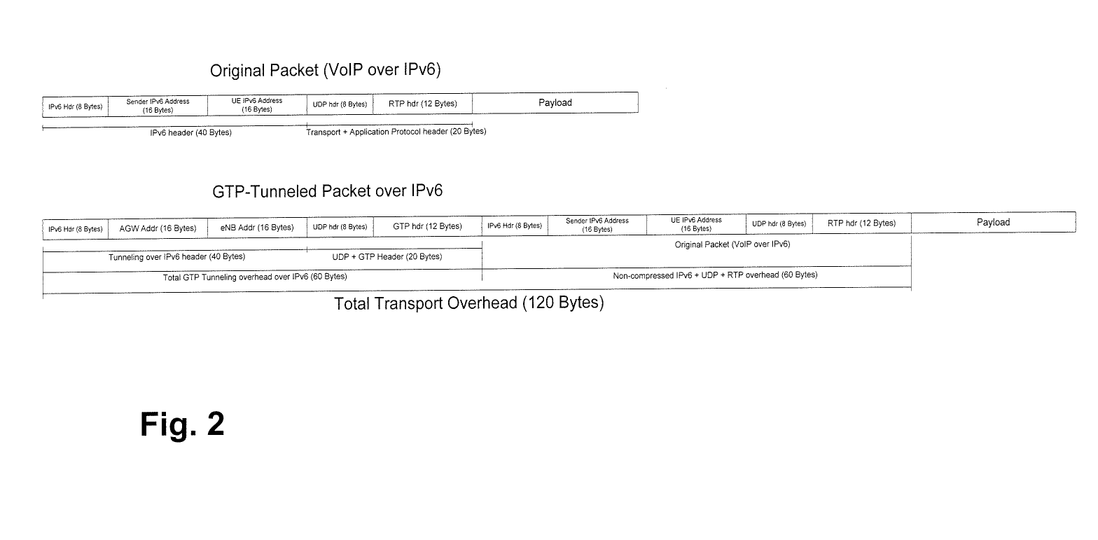

FIG. 2 illustrates a frame format for IPv6 over GTP (lower frame of FIG. 2) in comparison with an original VoIP over IP packet (upper frame of FIG. 2). The original VoIP packet requires an IPv6 header (40 Bytes) and transport and application protocol headers (20 Bytes) in addition to the payload data. The GTP-tunneled packet requires an additional tunneling-over-IPv6 header (40 Bytes) and additional UDP and GTP headers (20 Bytes). Thus, the total overhead amounts to 120 Bytes. The GTP-tunneling (non-secured) transport overheads can have various payload sizes, e.g. 32 Bytes payload (VoIP) with an overhead of 375%, 300 Bytes payload with overhead of 40%, or 1500 Bytes payload with an overhead of 8%.

In case GTP-tunneled packet are ciphered using ESP the transport overhead can be further increased in minimum with 16 Bytes (or even more depending on padding and authentication data variable length) i.e. the total transport overhead with secured GTP-tunneled Packet over IPv6 would be 136 Bytes. The secured (ESP) GTP-tunneling overheads with payload size of 32 Bytes (VoIP) leads to an overhead of 425%, with payload size of 300 Bytes payload to an overhead of 45%, and with payload size of 1500 Bytes to an overhead of 9%.

The transport overhead can be reduced by tunneling evolved GTP packets directly over link layer e.g. MPLS, Ethernet etc. Now removing the outer IPv6/UDP shall reduce overhead with 48 bytes. The GTP-U protocol may be merged with ESP function and header compression could be extended also for the carried user IP packet header. In this way the total transport overhead can be reduced into class of 20 Bytes.

Such a secured transmission leads to a lower overhead for the various payload sizes. Namely, an overhead of 63% at a payload of 32 Bytes (VoIP), an overhead of 7% at a payload of 300 Bytes, and an overhead of 1.3% at a payload of 1500 Bytes.

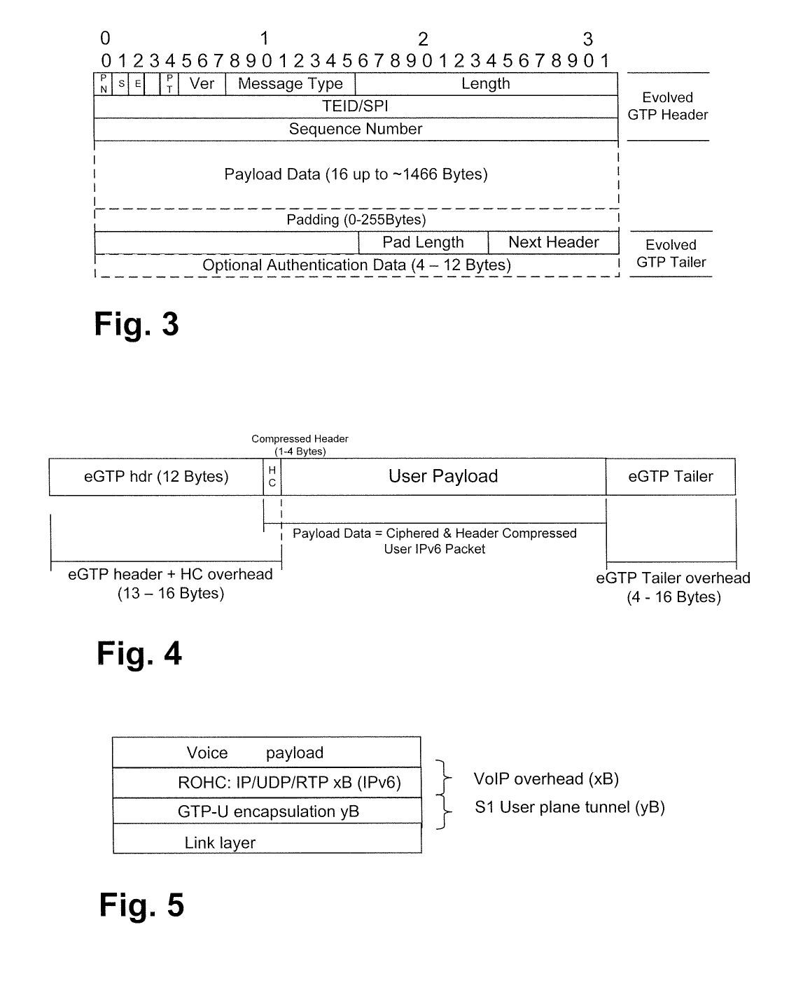

FIG. 3 shows an exemplary structure of an evolved GTP header according to an embodiment. Each line or row corresponds to 32 bytes. In GTP-U, authentication header and padding could be dispensed with. Padding can be used as an optional measure. The 16-bit-sequence number (SN) could be used to preserve transmission order e.g. for IPSec and an optional Robust Header Compression scheme (ROHC). The SN could however be increased to 32 bits as in ESP. Alternatively, a hyper frame number concept (HFN) concept, e.g. HFN+SN, could be used for GTP-U. Here, the ciphering sequence number (CSN) is composed of a ‘long’ sequence number (i.e. the HFN), and a ‘short’ sequence number (i.e. the SN). The HFN can be initialised by the UE before ciphering is started. It can be used as initial value for each ciphering sequence, and it is then incremented independently in each ciphering sequence, at each cycle of the ‘short’ sequence number.

Furthermore, a 32-bit-TEID can be used to identify a GTP tunnel in each node. A mapping function or table can be provided for mapping multiple TEIDs into security associations (SAs) which can be identified by respective SPIs.

As an alternative, special header compression for ESP and GTP-U can be provided to reduces at least one of GTP SN and ESP SN redundancy and TEID and SPI redundancy.

The evolved GTP (eGTP-U) can be transported directly over link layer MPLS, Ethernet etc. Data routing between tunnel endpoints can be done based on link layer addressing, e.g., Ethernet MAC. The eGTP-U header may contain version, message type and length information elements (IEs) (e.g. 4 Bytes). The TEID/SPI field can be used to identify an SAE bearer and security association (e.g. 4 Bytes). The SN of e.g. 4 bytes can be controlled via an S flag. Additionally, payload data can of 16 up to ˜1466 Bytes can be added, which contains the data described by a next header field. This field is an integral number of bytes in length. If the algorithm used to encrypt the payload requires cryptographic synchronization data, e.g., an initialization vector (IV), then this data may be carried explicitly in the payload data field.

The payload data can be ciphered or non-ciphered IPv6 or IPv4 user datagrams, which may be header compressed (e.g. ROCH) before ciphering. Padding may be required, irrespective of encryption algorithm requirements, to ensure that the resulting ciphered text terminates e.g. on a 4 byte boundary.

In the evolved GTP trailer, a padding length field specifies the size of the padding field in bytes. The additional next header filed may specify an IPv4/IPv6 protocol number describing the format of the payload data field. Furthermore, an optional authentication data field (e.g. 4-12 Bytes) may contain an ICV computed over the ESP packet minus the authentication data. The length of the field may be specified by the authentication function selected. This field is optional and is included only if the authentication service has been selected for the SA in question.

The total eGTP-U transport overhead without the impact of transport network link layer (e.g. MPLS or Ethernet framing) can be 16 to 28 Bytes depending on optional authentication function.

FIG. 4 illustrates an exemplary eGTP-U frame format for the payload data in a header compressed user IP packet. The eGTP header plus header compression overhead may consist of 13 to 16 Bytes and the eGTP trailer overhead may consist of 4 to 16 Bytes. Thus, the total transport overhead can vary between 17-32 Bytes depending on the header compression and optional authentication function. Additionally, the payload data can be a ciphered and header-compressed user IPv6 packet as indicated above.

FIG. 5 shows a schematic structure of a VoIP packet as transmitted over the S1 link according to an embodiment. In addition to a link layer header component shown at the bottom, a GTP-U encapsulation header with a number y of bytes (B) is provided for the S1 user plane tunnel. Optionally, a header compression (e.g. ROHC) can be provided for compressing the header components of the merged security layer or function. This compressed header portion may consist of a number x of bytes (B). The remaining packet portion includes the voice payload of the VoIP packet. The header compression may be based on the procedures described in the IETF (Internet Engineering Task Force) specifications RFC 4362 and RFC 3095.

According to an embodiment, GTP transport over link layer, e.g. MPLS, virtual LAN, Ethernet, metro Ethernet, ATM, xDSL, PPP link, etc. (or IP) is provided. For example, MPLS tunnels could be created between eNBs and user plane elements (e.g. aGWs or SAE GWs) and GTP-U packets could be transferred over MPLS. Transmission can be performed over link layers, so that no IP and UDP headers are required. The GTP tunnel is identified in each node with a TEID, an IP address and a UDP port number. As the UDP port number is in practice static, it is actually not needed. An implementation extension can be provided to identify SAE bearer route, i.e. a GTP tunnel can identified with a link layer address and a TEID instead of a TEID and an IP address.

According to another embodiment, NDS/IP or IPSec user plane can be merged with the GTP user plane (GTP-U) to establish an evolved GTP. Control plane (IKEv2) could remain the same. The control plane can be handled similarly as within NDS/IP.

In the control plane, SA negotiation can be implemented similar to NDS/IP (cf. 3GPP specification TS33.210), e.g. IKEv2 etc. Multiple TEIDs handled within one eNB can be mapped into a single IPSec SA (e.g. SPI). This can be achieved by maintaining a mapping table or mapping functionality to provide an association between between TEIDs and SPIs. This allows multiple SAs in one eNB and UPE (e.g. aGW or SAE GW) pair. The TEID/SPI mapping can be updated during handovers. To achieve this, an SPI or the like that identifies the SA between target eNB and corresponding UPE could be carried in the Handover Confirm message or another suitable handover signaling from eNB to the MME. UPE (downlink) and eNB (uplink) may then map the TEIDs to the correct SPI.

This allows migrating TEIDs and SPI values and there is thus no need to transfer both of them. Also, the handover signalling can indicate the associated lower (link) layer tunnel or IP address as the eNB needs to be identified somehow. For example if not with IP address, then with e.g. MPLS tunnel identifier.

It also possible to map an IPSec SPI to a lower link layer tunnel identifier and not directly to the GTP-U TEID. For example, the IPSec SPI could be mapped to the MPLS tunnel ID, or Virtual LAN ID, etc.

According to another embodiment, a reduction mechanism with GTP-C or some alternative protocol can be introduced. This is to make sure that both end points support the reduction mechanism, then to bootstrap IKEv2. Alternatively, IKEv2 could be extended to support the negotiation mechanism of GTP+ESP header compression. Also, the O&M (operation and maintenance) network functionality could be used to configure the endpoints to use reduction mechanism.

According to a further embodiment, re-keying could be used. This can be based on the GTP-U sequence number as a marker. To achieve this, endpoints can inform or negotiate the GTP-U SN from which on the new key is to be used. Thus, the SPI does not have to be carried in the packet itself, and the mapping can be updated between the tunnel and the new SPI (new SPI when keys change). The SPI is thus not needed in the GTP-U header and overhead can be further reduced. It is noted that different TEIDs may have different SPIs and thus also different SPD (Security Policy Database) and SAD (Security Association Database) entries

If a compression, such as ROHC is used, the GTP-U sequence number should be used to preserve packet order for S1 packets.

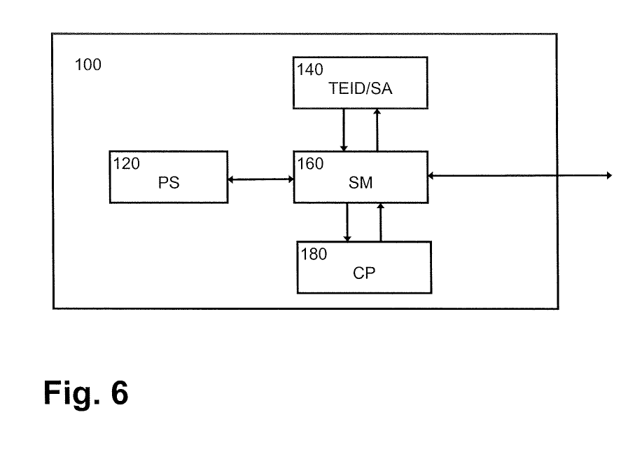

FIG. 6 shows a schematic structural or functional block diagram of a network device 100, such as an eNB or an UPE (e.g. aGW or SAE GW), in which the features of the above embodiments are at least partially implemented.

A processing stage 120 is provided for processing data packets which have been received or which are to be transmitted. At a security and mapping stage or unit 160, a secured or ciphered packet is generated by use of a security protocol layer functionality added or merged to a tunneling protocol layer (e.g. GTP). To achieve this, a mapping between a TEID of the tunneling protocol layer and an SA is provided by means of a mapping table or mapping function 140 which provides or stores respective TEID/SPI pairs, as explained above. The enhanced secured packet is received or transmitted by the network device over a link layer connection.

As an additional optional element, a compressing unit or stage 180 can be provided to implement the above explained compression functionality (e.g. ROHC or the like).

The individual blocks shown in FIG. 6 may be implemented as discrete hardware circuits or, alternatively, the functions of at least some of these blocks may be implemented as software routines of a computer programs stored in a program memory and controlling a processor element of a computer device (e.g. provided in the eNB, aGW, SAE GW or other comparable network device) to generate or execute steps required to implement those functions.

The tunneling protocol layer (e.g. GTP) can thus be enhanced by providing longer sequence number, i.e. from 16 bits to 32 bits. An “extended SN” extension can be created or a bit that indicates longer sequence number field (e.g. 32 bits) can be reserved. Furthermore, implementations of NDS/IP and GTP-U can be migrated and other functionality can be added to GTP. Multiple TEIDs handled within one eNB could be mapped into a single IPSec SA (e.g. SPI). Furthermore, a hook can be provided in the GTP-U processing stack for NDS/IP ciphering/deciphering.

As an alternative to the above mentioned TEID/SPI mapping, a lower layer link eNB address (e.g. MPLS tunnel ID) could be mapped to the SA, so that there is no need to map with TEID.

As a further alternative, a special header compression can be used for ESP and GTP-U, which effectively reduces redundancy of at least one of GTP SN, ESP SN, TEID and SPI. The reduction mechanism can be negotiated (e.g. with GTP-C) between endpoints (i.e. to know if the end point is GTPv1 or GTPv2 . . . ).

Two alternatives can thus be provided for mapping the SA (i.e. the SPI) with the user plane packets. The first one is to migrate ESP SPI and GTP-U TEID together with a mapping table. The second one is to have a mapping table between the ESP SPI and link layer tunnel identifier, such as a unique virtual LAN (VLAN) identity (ID) describing uniquely a connection between a eNB and an SAE GW. The SPI can be dropped from the packet header as the link layer tunnel identifier already uniquely points to the SA, e.g. connection between eNB and SAEGW.

With the second option there is no need to maintain the TEID (i.e. the GTP protocol tunnel identifier) with the ESP SPI, as the security association can be mapped directly to the link layer tunnel or link layer end point identifier. Furthermore, in the second option, there is no need to involve handover signaling to re-map TEIDs with SPIs (e.g. static secure tunnels between eNBs and SAE GW).

In another embodiment, the GTP control plane (GTP-C) messages, which are used to transfer GSN (GPRS support node) capability information between GSN pairs, to create, update and delete GTP tunnels and for path management, can be used to negotiate the header reduction mechanism. This means that the control plane protocol is used to check whether the other end point (e.g. eNB) supports transferring GTP-U over link layer or over IP, and if it supports combining ESP and GTP-U headers, and if it supports header compression of this combined header. This way the GTP protocol suite can be extended accordingly.

Two alternative solutions for implementation of ciphering and/or compression function in the user plane for a evolved 3GPP LTE/SAE network have been proposed, wherein the first alternative introduces a new protocol, which can be used independently to any under line protocol. The second alternative proposes to utilize eGTP-U (GPRS Tunneling protocol user plane) protocol, which reduces a protocol layer and is simple to implement.

To summarize, a method, tunnel protocol layer, and network device for securing a data packet on a network link have been described. A security layer is provided in the tunneling protocol layer of the wireless network, and a secured data packet is generated by adding to the data packet a header in accordance with said security layer of the tunneling protocol. The secured data packet is then transmitted over the link by using a link layer connection. It is noted that the proposed securing scheme can be applied to any kind of links on which secured data packets can be transmitted over tunneling protocols.

While there have been shown and described and pointed out fundamental features of the invention as applied to the embodiments thereof, it will be understood that various omissions and substitutions and changes in the form and details of the apparatus and method described may be made by those skilled in the art without departing from the present invention. For example, it is expressly intended that all combinations of those elements and/or method steps, which perform substantially the same function in substantially the same way to achieve the same results, be within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of designed choice. It is the intention, therefore, to be limited only as indicated by the scope of the claims appended hereto.

1. A method for securing a data packet on a network link, the method comprising:
providing a security layer in a tunneling protocol of said wireless network;
generating a secured data packet by adding to said data packet a header in accordance with said security layer of said tunneling protocol; and
using a link layer connection to transmit said secured data packet over said link.

2. A method according to claim 1, wherein the security layer is provided by merging said tunneling protocol with an Internet Protocol IP Security or Network Domain Security protocol.

3. A method according to claim 1, the method further comprising identifying said security association by a security parameter index.

4. A method according to claim 1, the method further comprising mapping a tunnel identifier of said tunneling protocol to a security association.

5. A method according to claim 4, wherein said tunnel identifier is a tunnel endpoint identifier TEID or a link layer tunnel identifier.

6. A method according to claim 1, the method further comprising compressing at least one of said header and security related fields prior to the transmission via said link layer connection.

7. A method according to claim 6, the method further comprising compressing at least one of a sequence number field and a tunnel endpoint identifier.

8. A method according to claim 6, the method further comprising performing the compression by using a Robust Header Compression scheme.

9. A method according to claim 7, the method further comprising using said compression to reduce at least one of a sequence number redundancy and a security payload redundancy.

10. A method according to claim 7, the method further comprising performing the compression by reducing overhead via a mapping between said tunnel endpoint identifier and a security parameter index field, so that said security parameter index field is no longer needed.

11. A method according to claim 1, wherein said network link is provided between an IP-based network and an access device of a wireless network.

12. A method according to claim 11, the method further comprising creating a link layer tunnel between said access device and a gateway device of a core network of said wireless network.

13. A method according to claim 12, wherein said link layer tunnel is a Multiprotocol Label Switching tunnel.

14. A method according to claim 1, the method further comprising adding to said header a field which indicates a ciphered or non-ciphered packet.

15. A method according to claim 1, the method further comprising remapping tunnel endpoint identifiers to security parameter indices by using handover signaling.

16. A method according to claim 15, wherein said handover signaling carries at least one of tunnel endpoint identifiers and security parameters indices.

17. A method according to claim 1, the method further comprising using a hyper frame number scheme for generating said header.

18. A method according to claim 1, the method further comprising mapping tunnels based on tunnel endpoint identifiers and link layer addresses.

19. A method according to claim 1, the method further comprising generating said header by combining an Encrypted Security Payload header with said tunneling protocol.

20. A method according to claim 1, wherein said data packet is a voice-over-IP packet.

21. A method according to claim 1, further comprising using control plane messages of said tunneling protocol to negotiate a header reduction mechanism.

22. A computer-readable storage medium comprising instructions representing a tunneling protocol layer in a user plane stack, said tunneling protocol layer being configured to provide a security function between an access device of a wireless network and a user plane element of a core network, wherein a tunnel identifier of said tunneling protocol layer is mapped to a security association and a link layer, and wherein a secured data packet is transmitted over a link layer connection.

23. A computer-readable storage medium according to claim 22, wherein the security protocol layer is further configured to apply compression to said secured data packet before transmission via said link layer connection.

24. A computer-readable storage medium according to claim 22, wherein said tunneling protocol is a General Packet Radio Services tunneling protocol.

25. A network device for securing a data packet on a network link, the network device comprising:
a packet generation unit for generating a secured data packet by adding to said data packet a header in accordance with a security layer of a tunneling protocol; and
a transmitting unit for using a link layer connection to transmit said secured data packet over said link.

26. A network device according to claim 25, further comprising a mapping unit for mapping a tunnel identifier of said tunneling protocol to a security association.

27. A network device according to claim 25, wherein the security layer is provided by merging said tunneling protocol with an IP-based security protocol.

28. A network device according to claim 26, wherein said security association is identified by a security parameter index.

29. A network device according to claim 28, wherein said IP-based security protocol is the IP Security or the Network Domain Security protocol.

30. A network device according to claim 25, the network device further comprising a compression unit for compressing at least one of said header and security related fields prior to the transmission via said link layer connection.

31. A network device according to claim 30, wherein said compression unit is configured to compress at least one of a sequence number field and a tunnel endpoint identifier.

32. A network device according to claim 30, wherein said compression unit is configured to perform compression by using a Robust Header Compression scheme.

33. A network device according to claim 31, wherein said compression unit is configured to reduce overhead via a mapping between said tunnel endpoint identifier and a security parameter index field, so that said security parameter index field is no longer needed.

34. A network device according to claim 25, wherein said transmission unit is configured to create a link layer tunnel for transmission of the secured data packet.

35. A network device according to claim 34, wherein said link layer tunnel is a Multiprotocol Label Switching tunnel.

36. A network device according to claim 25, wherein said header generation unit is configured to add to said header a field which indicates a ciphered or non-ciphered packet.

37. A network device according to claim 25, wherein said mapping unit is configured to remap tunnel endpoint identifiers to security parameter indices by using handover signaling.

38. A network device according to claim 37, wherein said handover signaling carries at least one of tunnel endpoint identifiers and security parameters indices.

39. A network device according to claim 25, wherein said header generation unit is configured to use an HFN+SN scheme for generating said header.

40. A network device according to claim 25, wherein said mapping unit is configured to map tunnels based on tunnel endpoint identifiers and link layer addresses.

41. A network device according to claim 25, wherein said header generation unit is configured to generate said header by combining an Encrypted Security Payload header with said tunneling protocol.

42. A network device according to claim 25, wherein said data packet is a voice-over-IP packet.

43. A network device according to claim 25, wherein said network device is a user plane element of a core network or an access device of a wireless network.

44. A computer program stored on a computer readable medium and comprising code means for generating the steps of method claim 1 when run on a computer device.

45. A network device for securing a data packet on a network, the network device comprising:
stacked protocol means with a tunneling protocol having a security layer;
packet generation means for generating a secured data packet by adding to said data packet a header in accordance with said security layer of said tunneling protocol; and
transmitting means for using a link layer connection to transmit said secured data packet over said link.
